(19) United States
(12) Patent Application Publication
(10) Pub. No.: US 2019/0101211 A1
(43) Pub. Date: Apr. 4, 2019

(54) SEALING DEVICE

(71) Applicant: NOK CORPORATION, Tokyo (JP)

(72) Inventor: Kazunori JINBO, Ibaraki-shi (JP)

(21) Appl. No.: 16/147,975

(22) Filed: Oct. 1, 2018

(30) Foreign Application Priority Data
Oct. 4, 2017 (JP) 2017-194469

(51) Int. Cl. F16J 9/20

(52) U.S. Cl. CPC F16J 9/20

(57) ABSTRACT

The sealing device includes a sealing member and a ring member. The sealing member has a groove and a slit, the groove being formed to have an annular shape in a circumferential direction along the sliding surface, and the slit being formed so as to allow communication from a side surface of the sealing member to the groove. The sealing member includes a contamination sealing portion which functions as a contamination seal and a hydraulic sealing portion which functions as a hydraulic seal, the contamination sealing portion being formed of a portion of the sliding surface disposed at a position outward from the groove, and the hydraulic sealing portion being formed of a portion of the sliding surface disposed at a position inward from the groove.

### CROSS REFERENCE TO RELATED APPLICATIONS

This application claims the benefit of Japanese Patent Application No. 2017-194469, filed Oct. 4, 2017, which is hereby incorporated by reference in its entirety.

### BACKGROUND

### Technical Field

The present disclosure relates to a sealing device, and more particularly to a sealing device which seals a portion at which a piston performs reciprocating motion with respect to a cylinder.

### Background

Conventionally, in a hydraulic cylinder for a construction machine, as shown in FIG. 9, a piston sealing system 1000 is provided between a piston 500 and a cylinder 600, thus sealing an annular gap formed between an outer peripheral surface 500a of the piston 500 and an inner peripheral surface 600a of the cylinder 600.

In the piston sealing system 1000, an annular groove 501 is formed on the outer peripheral surface 500a of the piston 500 at the center in the stroke direction, and a piston seal 530 is mounted in the annular groove 501 as a packing. Two wear rings 540, 550 are mounted, as bearings, on the outer peripheral surface 500a of the piston 500 at positions on both sides of the piston seal 530. At the same time, two contamination seals 560, 570 are mounted on the outer peripheral surface 500a at positions further outward from the wear rings 540, 550 (refer to JP-U-Hei2-12505, for example).

The piston seal 530 is mounted in the annular groove 501. The piston seal 530 includes a seal ring 510 and an O-ring 520. The seal ring 510 is made of a hard material such as nylon. The O-ring 520 is formed of a rubber elastic member, and presses the seal ring 510 toward the inner peripheral surface 600a of the cylinder 600.

The wear rings 540, 550 are used for preventing sticking between the piston 500 and the cylinder 600 and for reducing eccentricity between the piston 500 and the cylinder 600, thus enhancing durability and sealability of the piston seal 530.

The contamination seals 560, 570 are mainly made of a PTFE (polytetrafluoroethylene) material. As shown in FIG. 10A, the contamination seals 560, 570 physically block foreign substances 700 such as dust (contamination) in oil thus inhibiting the foreign substances 700 from intruding into the piston seal 530 disposed at the position inward from the contamination seals 560, 570.

Further, as shown in FIG. 10B, when the contamination seal 560 is pressed against the cylinder 600 in a state where the foreign substances 700 are interposed between a sealing surface of the contamination seal 560 and the cylinder 600, the contamination seal 560 is permanently deformed with the foreign substances 700 embedded since the contamination seal 560 is formed of an elastoplastic body. Accordingly, there is no possibility of the foreign substances 700 projecting from the sealing surface. Therefore, the contamination seal 560 prevents the foreign substances 700 from damaging the inner peripheral surface 600a of the cylinder 600 when the outer peripheral surface 500a of the piston 500 slides on the inner peripheral surface 600a of the cylinder 600.

### SUMMARY

However, in the piston sealing system 1000, there may be a case where sufficient spaces for mounting the contamination seals 560, 570 cannot be ensured in the stroke direction of the piston 500 and, further, oil contains a large amount of foreign substances 700. For example, in the case of a hydraulic drive part for a machine tool, when foreign substances 700, such as cutting chips, are mixed into oil, if the contamination seals 560, 570 are not mounted, due to the intrusion of the foreign substances 700, a sealing surface of the seal ring 510 of the piston seal 530 may be damaged. Such damage may cause damage of the inner peripheral surface 600a of the cylinder 600, thus leading to flowing of oil through between the sealing surface and the inner peripheral surface 600a. Therefore, original performance of the piston seal 530 may drop, thus leading to a shorter lifespan.

The present disclosure is related to providing a sealing device which can maintain original performance by preventing intrusion of foreign substances even when a contamination seal is not able to be mounted, thus having a long lifetime.

In accordance with one aspect of the present disclosure, a sealing device is mounted in an recessed part having an annular shape and formed on an inner peripheral surface of a cylinder or on an outer peripheral surface of a piston which moves on the inner peripheral surface of the cylinder along an axial direction, the recessed part having a predetermined depth in a radial direction orthogonal to the axial direction. The sealing device includes: a sealing member having an annular shape and having a sliding surface which slidably contacts with the inner peripheral surface of the cylinder or with the outer peripheral surface of the piston; and a ring member having an annular shape and made of an elastic material which presses the sealing member toward the inner peripheral surface of the cylinder or toward the outer peripheral surface of the piston. The sealing member has a groove and a slit, the groove being formed to have an annular shape in a circumferential direction along the sliding surface, and the slit being formed so as to allow communication from a side surface of the sealing member to the groove. The sealing member includes a contamination sealing portion which functions as a contamination seal and a hydraulic sealing portion which functions as a hydraulic seal, the contamination sealing portion being formed of a portion of the sliding surface disposed at a position outward from the groove, and the hydraulic sealing portion being formed of a portion of the sliding surface disposed at a position inward from the groove.

In the sealing device according to one aspect of the present disclosure, surface roughness of the portion of the sliding surface forming the contamination sealing portion is greater than surface roughness of the portion of the sliding surface forming the hydraulic sealing portion.

In the sealing device according to one aspect of the present disclosure, a depth of the slit is set equal to a depth of the groove.

In the sealing device according to one aspect of the present disclosure, the slit increases in dimension from the groove to the side surface of the sealing member.

According to the sealing device of the present disclosure, it is possible to realize a sealing device which can maintain original performance by preventing intrusion of foreign substances even when a contamination seal is not able to be mounted, thus having a long lifetime.

### BRIEF DESCRIPTION OF THE DRAWINGS

FIG. 1 is a cross-sectional view showing a mounted state of a sealing device according to an embodiment of the present disclosure;

FIG. 2 is a perspective view showing an external configuration of the sealing device according to the embodiment of the present disclosure;

FIG. 3 is a partially enlarged cross-sectional view showing a cross-sectional structure of the sealing device according to the embodiment of the present disclosure;

FIG. 4 is a cross-sectional view showing an operation state of the sealing device according to the embodiment of the present disclosure;

FIGS. 5A and 5B are perspective views showing an external configuration of a sealing device (1) according to another embodiment of the present disclosure;

FIG. 6 is a cross-sectional view showing a configuration of a sealing device (2) according to another embodiment of the present disclosure;

FIG. 7 is a cross-sectional view showing a configuration of a sealing device (3) according to another embodiment of the present disclosure;

FIG. 8 is a cross-sectional view showing a mounted state of the sealing device (3) according to another embodiment of the present disclosure;

FIG. 9 is a schematic cross-sectional view showing a configuration of a conventional piston sealing system; and

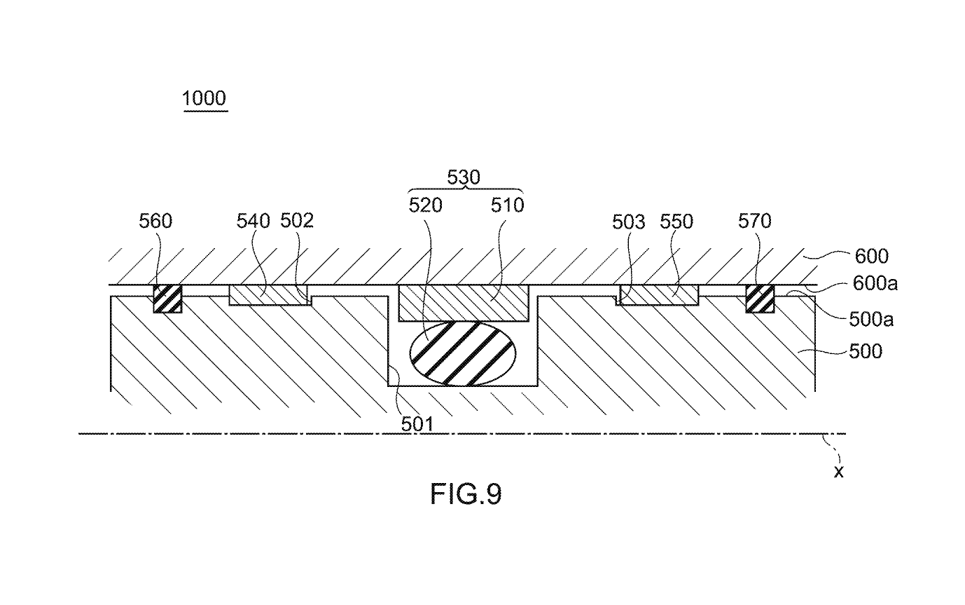

FIGS. 10A and 10B are schematic cross-sectional views for describing a function of a conventional contamination seal.

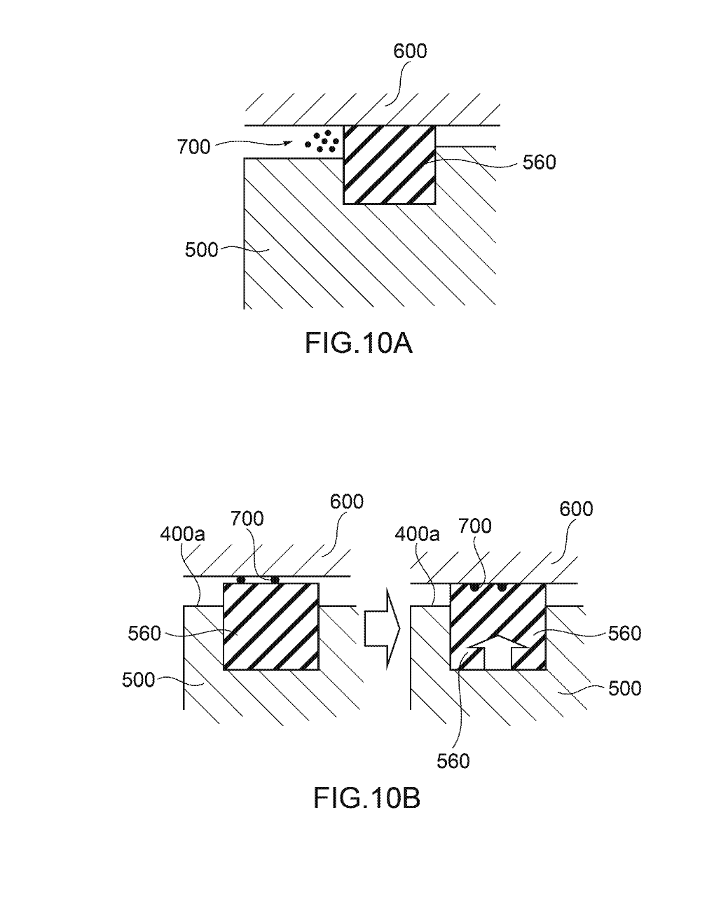

### DETAILED DESCRIPTION

Hereinafter, embodiments of the present disclosure will be described with reference to the accompanying drawings.

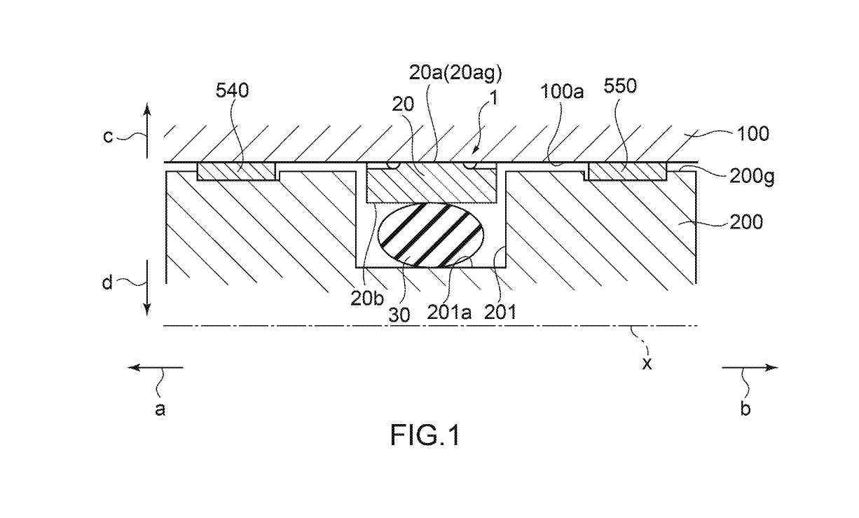

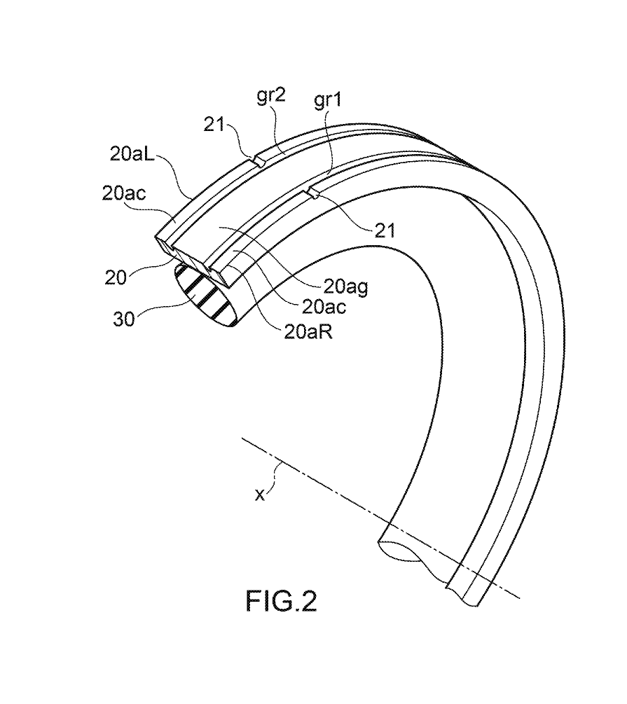

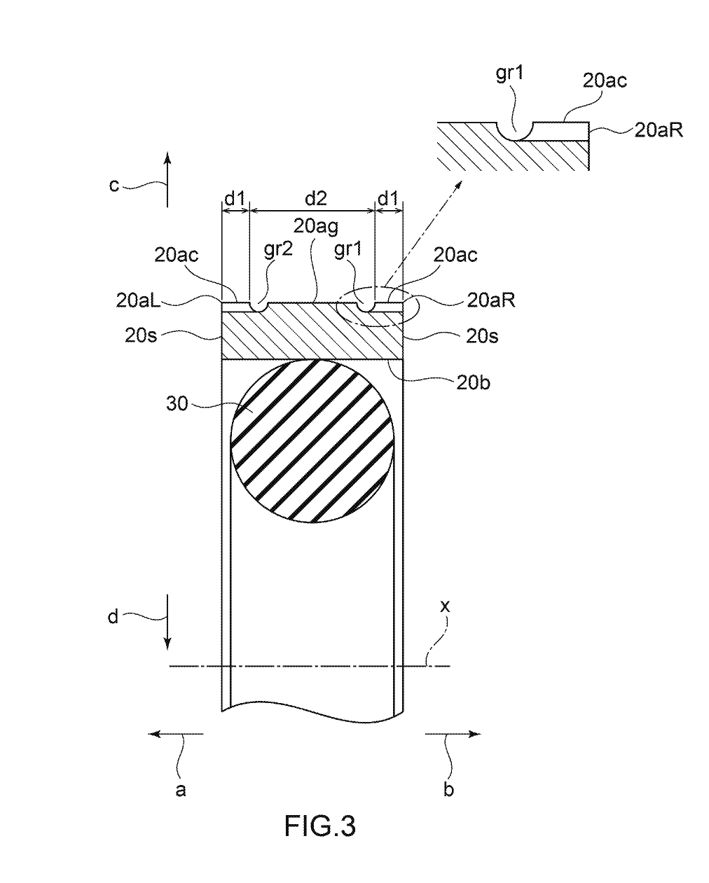

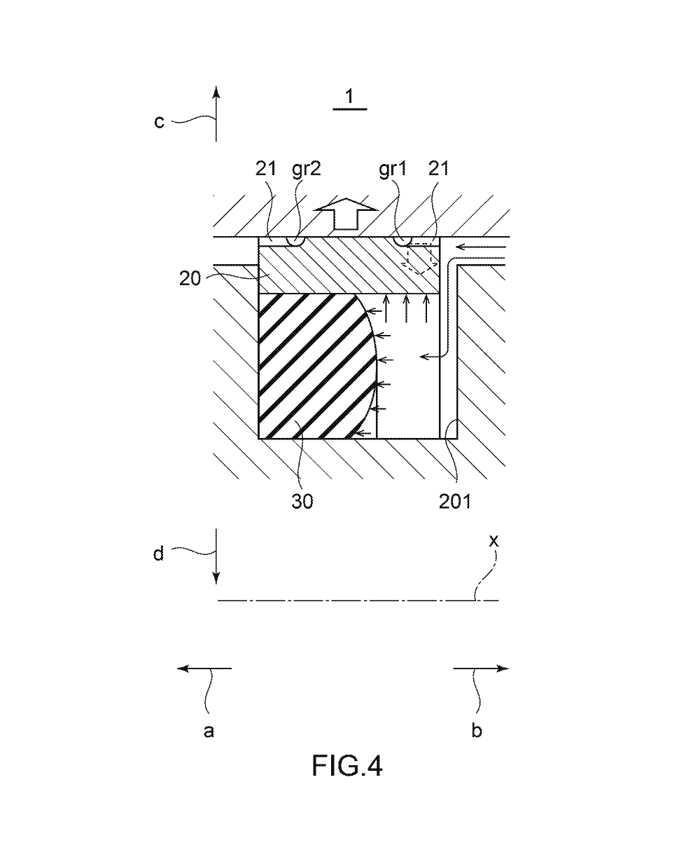

FIG. 1 is a perspective view showing an external configuration of a sealing device according to the embodiment of the present disclosure. FIG. 2 is a partially enlarged cross-sectional view showing a cross-sectional structure of the sealing device according to the embodiment of the present disclosure. FIG. 3 is a cross-sectional view showing a mounted state of the sealing device according to the embodiment of the present disclosure. FIG. 4 is a cross-sectional view showing an operation state of the sealing device according to the embodiment of the present disclosure.

Hereinafter, for the purpose of convenience of the description, in the direction in FIG. 1 to FIG. 4 indicated by arrows a and b along the axis x (hereinafter, also referred to as “stroke direction”), the direction which is indicated by the arrow a along the direction of the axis x is assumed as the left side, and the direction which is indicated by the arrow b along the direction of the axis x is assumed as the right side. Further, in the direction which is orthogonal to the axis x and is indicated by arrows c and d (hereinafter, also referred to as “radial direction”), the direction pointing away from the axis x (the direction indicated by the arrow c) is assumed as the outer periphery side, and the direction pointing toward the axis x (the direction indicated by the arrow d) is assumed as the inner periphery side.

### First Embodiment

As shown in FIG. 1 to FIG. 4, a sealing device 1 according to a first embodiment of the present disclosure is provided for sealing the space formed between a cylinder 100 and a piston 200 of a hydraulic cylinder for a construction machine. Particularly, as shown in FIG. 1, the sealing device 1 is effectively used for a piston sealing system where a length of the piston 200 in the stroke direction is short so that a contamination seal (not shown in the drawing) is not able to be mounted on the piston 200 at positions outward from wear rings 540, 550.

The cylinder 100 is a cylindrical hydraulic cylinder having an inner peripheral surface 100a having a predetermined inner diameter, and the inner peripheral surface 100a extends in the stroke direction (the direction indicated by arrows a and b) along the axis x. The piston 200 is a cylindrical hydraulic piston having a predetermined outer diameter, and is formed as an integral body with a piston rod not shown in the drawing. The piston 200 has an outer peripheral surface 200g which is parallel to the inner peripheral surface 100a of the cylinder 100 and extends along the axis x. The piston 200 moves slidably on the inner peripheral surface 100a of the cylinder 100.

The piston 200 has an annular groove 201 as a recessed part on the outer peripheral surface 200g at the center or at substantially the center in the stroke direction (the direction indicated by the arrows a and b), and the annular groove 201 has a quadrangular shape in cross section. The sealing device (piston seal) 1 is mounted in the annular groove 201 as a packing. However, the structure of the piston 200 is not limited to such a configuration. The inner peripheral surface 100a of the cylinder 100 may have an annular groove (not shown in the drawing), having a quadrangular shape in cross section, at the center or at substantially the center in the stroke direction (the direction indicated by the arrows a and b), and the sealing device (piston seal) 1 may be mounted in the annular groove.

### <Configuration of Sealing Device>

As shown in FIG. 1, the sealing device 1 seals an annular gap formed between the cylinder 100 and the piston 200, thus partitioning the inside of the cylinder 100 into a space on the left side (the direction indicated by the arrow a) in FIG. 1 and a space on the right side (the direction indicated by the arrow b) in FIG. 1.

As shown in FIG. 2, the sealing device 1 includes a seal ring 20 as a sealing member, and an O-ring 30 as a ring member. The sealing device 1 is a combined seal where the seal ring 20 and the O-ring 30 are combined as an integral body.

The seal ring 20 is made of a resin material. Such a resin may be a soft resin, such as polytetrafluoroethylene (PTFE), otherwise a hard resin, such as polyether ether ketone (PEEK), a polyphenylene sulfide resin (PPS), or nylon 6, 6. The O-ring 30 is made of an elastic material such as rubber. Such a rubber may be nitrile rubber (NBR), fluororubber (FKM), ethylene-propylene rubber (EPDM) or the like, for example.

The length of the seal ring 20 in the stroke direction (the direction indicated by the arrows a and b) along the axis x, that is, the width of the seal ring 20, is set equal to or slightly smaller than the width of the annular groove 201 of the piston 200 in the stroke direction (the direction indicated by the arrows a and b). The diameter of the O-ring 30 is set equal to or slightly smaller than the width of the seal ring 20.

The seal ring 20 is an annular ring member having a quadrangular shape in cross section (a rectangular shape in cross section in the case of the present embodiment). The seal ring 20 has a sliding surface 20a and a mounting surface 20b. The sliding surface 20a is disposed on the side where the seal ring 20 slides on the inner peripheral surface 100a of the cylinder 100. The mounting surface 20b is disposed on the side where the O-ring 30 is mounted on the seal ring 20 as an integral body.

Grooves gr1, gr2 are formed on the sliding surface 20a of the seal ring 20. The grooves gr1, gr2 extend in the circumferential direction and have a continuous annular shape. The grooves gr1, gr2 have the same structure, and extend parallel to each other along the circumferential direction. Each of the grooves gr1, gr2 has a substantially semicircular shape in cross section, and is formed with a predetermined depth. The grooves gr1, gr2 are not limited to have a substantially semicircular shape in cross section, and may have a substantially quadrangular shape or any of various other shapes in cross section. These grooves gr1, gr2 are formed by cutting or any of various other methods, for example.

The grooves gr1, gr2 are respectively formed at positions separated from end edges 20aR, 20aL of the sliding surface 20a by a predetermined distance d1. Further, the grooves gr1, gr2 are formed in a spaced-apart manner by a distance d2, and a relationship of distance d2>distance d1 is established. However, the configuration of the grooves gr1, gr2 is not limited to the above, and a relationship of distance d2=distance d1, or a relationship of distance d2<distance d1 may be established.

In the present embodiment, a portion of the sliding surface 20a on the left side (the direction indicated by the arrow a) at a position outward from the groove gr2 forms a sliding surface portion 20ac, and a portion of the sliding surface 20a on the right side (the direction indicated by the arrow b) at a position outward from the groove gr1 forms a sliding surface portion 20ac. Each sliding surface portion 20ac blocks foreign substances 700 and, at the same time, even if foreign substances 700 intrude into the sealing device, the sliding surface portion 20ac permanently deforms in a state where the foreign substances 700 are embedded into the sliding surface portion 20ac, thus functioning as a contamination sealing portion which prevents the foreign substances 700 from projecting from a sealing surface (hereinafter, the sliding surface portion 20ac is referred to as “contamination sealing portion 20ac”).

On the other hand, a sliding surface portion 20ag of the sliding surface 20a which is disposed at a position inward from the grooves gr1, gr2, that is, between the grooves gr1, gr2, seals an annular gap formed between the cylinder 100 and the piston 200, thus functioning as a hydraulic sealing portion which partitions the inside of the cylinder 100 into a space on the left side (the direction indicated by the arrow a) and a space on the right side (the direction indicated by the arrow b) (hereinafter, the sliding surface portion 20ag is referred to as “hydraulic sealing portion 20ag”).

That is, the sliding surface 20a of the seal ring 20 has two contamination sealing portions 20ac disposed at positions outward from the grooves gr1, gr2 and one hydraulic sealing portion 20ag disposed at the position inward from the grooves gr1, gr2 in a distributed manner.

In the present embodiment, surfaces of the two contamination sealing portions 20ac has greater surface roughness than a surface of the hydraulic sealing portion 20ag due to coating treatment, adjustment of surface roughness, surface modification treatment or the like.

Further, each of the two contamination sealing portions 20ac has slits 21 formed so as to allow communication from a side surface 20s of the seal ring 20 to the grooves gr1, gr2. To be more specific, each of the contamination sealing portions 20ac has a plurality of the slits 21 extending orthogonal to the circumferential direction, and the slits 21 allow communication between the side surface 20s and the grooves gr1, gr2. For example, four slits 21 are equidistantly formed in the circumferential direction at 90-degree intervals.

Each slit 21 has a substantially semicircular shape in cross section, and is formed with a predetermined depth. The slits 21 are not limited to have a substantially semicircular shape in cross section, and may have a substantially quadrangular shape or any of various other shapes in cross section. Further, the depth of the slits 21 in the radial direction (the direction indicated by the arrows c and d) is set equal to the depth of the grooves gr1, gr2. However, the depth of the slits 21 is not limited to the above. The depth of the slits 21 may be set smaller than the depth of the grooves gr1, gr2.

### <Operation of Sealing Device>

As shown in FIG. 1, when the sealing device 1 having such a configuration is mounted in the annular groove 201 of the piston 200, between the inner peripheral surface 100a of the cylinder 100 and the outer peripheral surface 200g of the piston 200, the O-ring 30 contacts an inner peripheral surface (bottom surface) 201a of the annular groove 201 of the piston 200 with a predetermined compression margin in cross section.

Accordingly, the seal ring 20 is pressed against the inner peripheral surface 100a of the cylinder 100 due to an elastic force of the O-ring 30 so that the sealing device 1 seals an annular gap formed between the cylinder 100 and the piston 200. In such a state, when oil is introduced into the cylinder 100 from the outside of the cylinder 100, the piston 200 relatively moves in the stroke direction (the direction indicated by the arrows a and b) extending along the axis x due to an oil pressure of the oil.

In the sealing device 1, due to repeated pressurization caused when the piston 200 performs reciprocating motion in the stroke direction (the direction indicated by the arrows a and b) with respect to the cylinder 100, swelling deformation may occur in the contamination sealing portion 20ac of the seal ring 20. Also in such a case, the hydraulic sealing portion 20ag and the contamination sealing portions 20ac are separated from each other due to the presence of the grooves gr1, gr2 formed on the sliding surface 20a and hence, it is possible to reduce an effect on the hydraulic sealing portion 20ag from the swelling deformation formed in the contamination sealing portion 20ac.

In the sealing device 1, the surface of the contamination sealing portion 20ac is coarser than the surface of the hydraulic sealing portion 20ag. Accordingly, the surface of the contamination sealing portion 20ac can easily catch the foreign substances 700, thus reducing a risk that the foreign substances 700 intrude into the hydraulic sealing portion 20ag.

Due to the presence of the contamination sealing portions 20ac, the sealing device 1 can block and inhibit intrusion of the foreign substances 700. Even if the foreign substances 700 intrude into and pass through the contamination sealing portion 20ac, the foreign substances 700 are temporarily released into the space of the grooves gr1, gr2. Accordingly, it is possible to prevent the hydraulic sealing portion 20ag from catching the foreign substances 700.

The sealing device 1 has the slits 21 which communicate with the grooves gr1, gr2, thus facilitating introduction and discharge of oil. Accordingly, it is possible to avoid an accumulated pressure of an oil pressure with respect to the grooves gr1, gr2.

Further, as shown in FIG. 4, in the sealing device 1, due to an oil pressure applied to the O-ring 30 from the right side (the direction indicated by the arrow b), an internal pressure toward the outer periphery side (the direction indicated by the arrow c) is generated in the seal ring 20 so that a force (expansion force) is generated which presses the seal ring 20 against the inner peripheral surface 100a of the cylinder 100.

However, in the sealing device 1, the oil pressure from the slits 21 toward the groove gr1 acts as a cancellation pressure toward the inner periphery side (the direction indicated by the arrow d) with respect to the contamination sealing portion 20ac of the seal ring 20, thus reducing the force (expansion force) which presses the hydraulic sealing portion 20ag against the inner peripheral surface 100a of the cylinder 100. As a result, in the sealing device 1, a sliding resistance, against the cylinder 100, which is caused by reciprocating motion of the piston 200 in the stroke direction is reduced so that operability of the sealing device 1 is enhanced.

As described above, the sealing device 1 can exhibit sealing performance with small sliding resistance and excellent operability while having a function as a contamination seal. Further, the sealing device 1 can exhibit advantageous effects equal to or higher than the advantageous effects which can be acquired by a sealing device provided with a contamination seal additionally while the sealing device 1 maintains the same size as the conventional sealing device.

Accordingly, it is possible to realize the sealing device 1 which can maintain original performance by preventing intrusion of foreign substances 700 even when the contamination seal is not able to be mounted, thus having a long lifetime.

### Second Embodiment

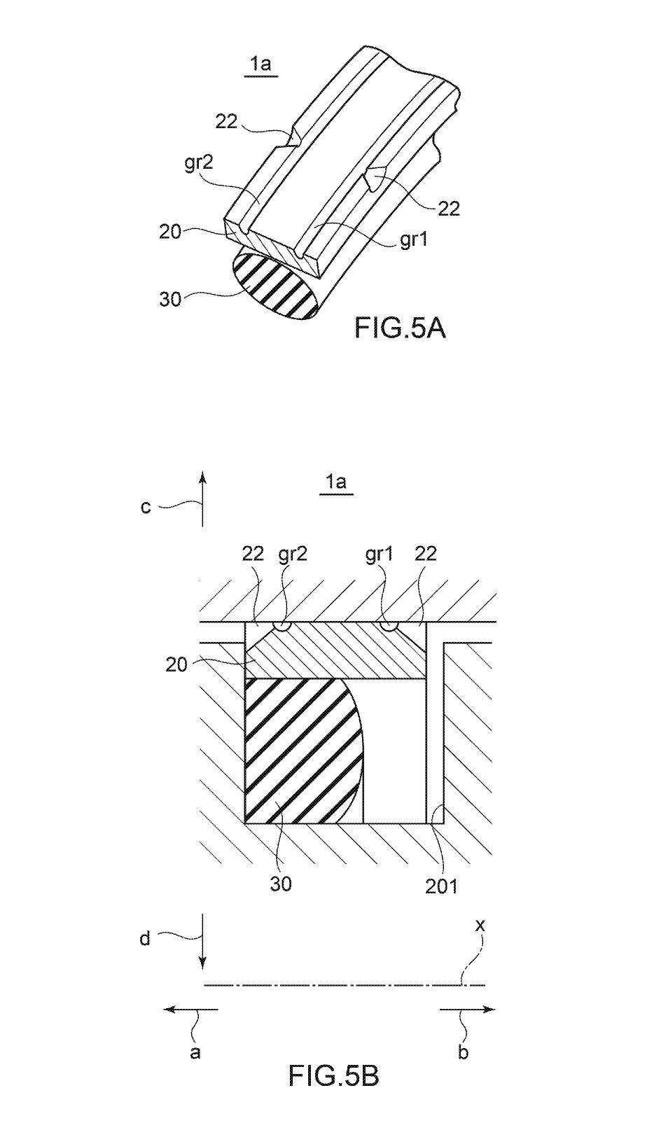

Components in FIGS. 5A and 5B which correspond to the components in FIG. 2 and FIG. 3 are given the same characters. As shown in FIGS. 5A and 5B, a sealing device 1a of a second embodiment is equal to the sealing device 1 of the first embodiment with respect to a point that the sealing device 1a includes the seal ring 20 and the O-ring 30. However, the sealing device 1a of the second embodiment differs from the sealing device 1 of the first embodiment with respect to the configuration of slits 22 of the seal ring 20.

Each slit 22 has a semicircular shape in cross section, and the diameter of the slit 22 gradually increases from the grooves gr1, gr2 toward the side surface 20s disposed on the outer side of the seal ring 20. The sealing device 1a includes the seal ring 20 on which the slits 22 having such a shape are formed. Accordingly, oil can be easily introduced into and discharged through the slits 22 and hence, it is possible to prevent the case where oil flows through between the hydraulic sealing portion 20ag and the inner peripheral surface 100a of the cylinder 100 due to an oil pressure.

### Third Embodiment

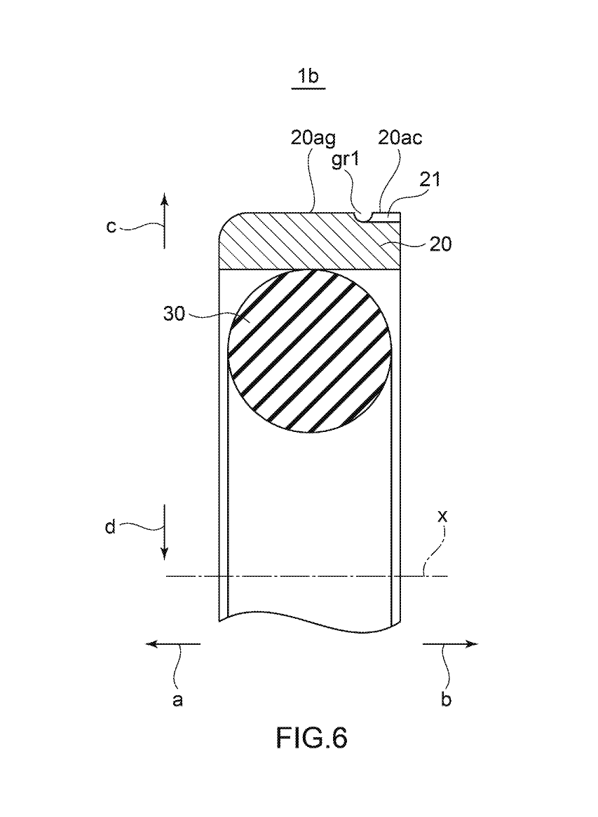

Components in FIG. 6 which correspond to the components in FIG. 3 are given the same characters. As shown in FIG. 6, a sealing device 1b of a third embodiment is configured such that only one groove gr1 is formed on a sliding surface 20a of the seal ring 20.

That is, in the sealing device 1b, a portion of the sliding surface 20a outward from the groove gr1 to the side surface 20s forms a contamination sealing portion 20ac, and a remaining portion of the sliding surface 20a from the groove to the opposite side surface 20s forms a hydraulic sealing portion 20ag. Also in such a case, it is possible to acquire substantially the similar advantageous effects as the sealing device 1 of the above-mentioned first embodiment.

### Fourth Embodiment

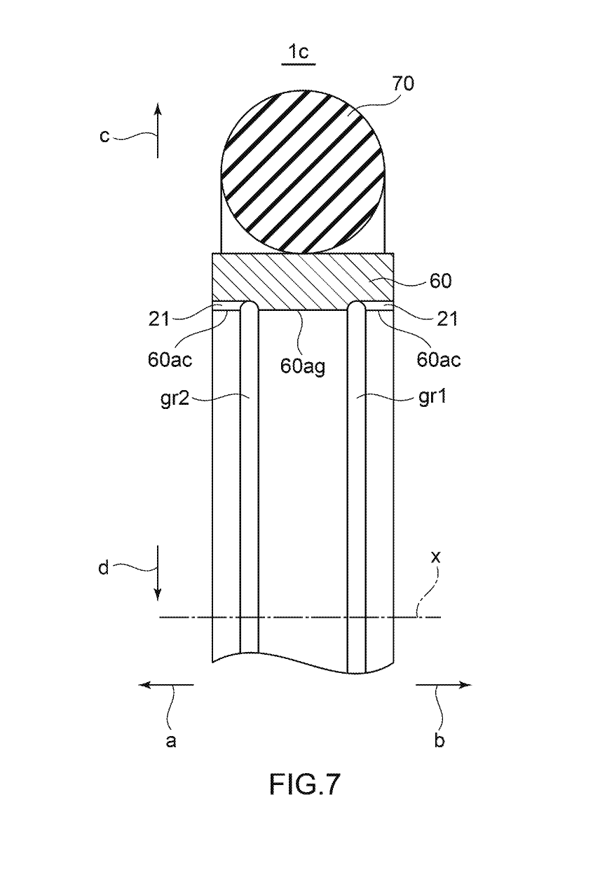

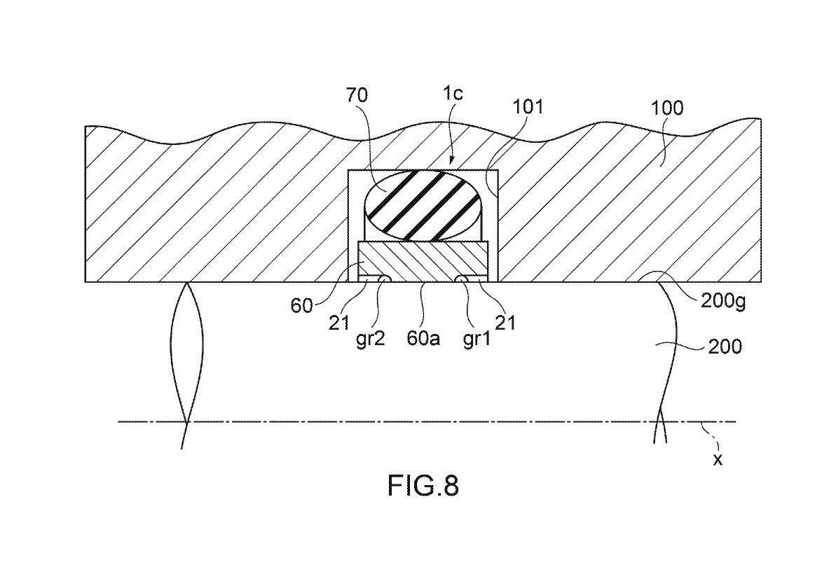

As shown in FIG. 7 and FIG. 8, a sealing device 1c according to a fourth embodiment is configured such that an O-ring 70 and a seal ring 60 are integrally joined with each other with the O-ring 70 positioned on the outer periphery side (the direction indicated by the arrow c) and with the seal ring 60 positioned on the inner periphery side (the direction indicated by the arrow d).

The seal ring 60 and the O-ring 70 of the sealing device 1c have the same basic structures as the seal ring 20 and the O-ring 30 of the sealing device 1 according to the first embodiment. However, an inner peripheral surface of the seal ring 60 forms a sliding surface 60a which slidably contacts with the outer peripheral surface 200g of the piston 200. The grooves gr1, gr2 are formed on the sliding surface 60a in the similar manner as the sealing device 1. Accordingly, the sealing device 1c has two contamination sealing portions 60ac and one hydraulic sealing portion 60ag using the grooves gr1, gr2 as boundaries.

The sealing device 1c is configured such that the outer peripheral surface 200g of the piston 200 and the sliding surface 60a of the seal ring 60 slidably contact with each other. Different from the sealing device 1 according to the first embodiment, a target of a slide contact is not the inner peripheral surface 100a of the cylinder 100. However, the sealing device 1c can acquire substantially the similar advantageous effects as the first embodiment.

### Other Embodiments

In the above-mentioned embodiments, the description has been made with respect to the case where the two grooves gr1, gr2 are formed on the sliding surface 20a of the seal ring 20 of the sealing device 1. However, the present disclosure is not limited to such a configuration. Two or more grooves, for example, four grooves gr1 to gr4, may be formed on the sliding surface 20a.

In the above-mentioned embodiments, the description has been made with respect to the case where the four slits 21 are equidistantly disposed in the circumferential direction at 90-degree intervals. However, the present disclosure is not limited to such a configuration. Three, six, or various number of slits 21 may be formed. In short, the number of slits may be desirably determined according to the degree of sliding resistance to be reduced by a cancellation pressure.

Although preferred embodiments of the present disclosure have been described heretofore, the present disclosure is not limited to the sealing device 1 according to the above-mentioned embodiments, and includes any mode which falls within the concept and Claims of the present disclosure. Further, respective configurations may be selectively combined as desired such that the above-mentioned problems or advantageous effects can be at least partially solved or acquired. For example, a shape, a material, an arrangement, a size or the like of the respective constitutional elements of the above-mentioned embodiments is changeable as desired according to a specific use mode of the present disclosure.

The case has been described where the sealing device according to the present disclosure is applied for the purpose of sealing a space formed between the cylinder 100 and the piston 200 of the hydraulic cylinder for a construction machine when performing reciprocating motion. However, the sealing structure or the sealing device of the present disclosure may be applied for the purpose of sealing a space formed between a cylinder and a piston in an automobile or the like when performing reciprocating motion.

What is claimed is:

1. A sealing device which is mounted in an recessed part having an annular shape and formed on an inner peripheral surface of a cylinder or on an outer peripheral surface of a piston which moves on the inner peripheral surface of the cylinder along an axial direction, the recessed part having a predetermined depth in a radial direction orthogonal to the axial direction, the sealing device comprising:
a sealing member having an annular shape and having a sliding surface which slidably contacts with the inner peripheral surface of the cylinder or with the outer peripheral surface of the piston; and
a ring member having an annular shape and made of an elastic material which presses the sealing member toward the inner peripheral surface of the cylinder or toward the outer peripheral surface of the piston, wherein
the sealing member has a groove and a slit, the groove being formed to have an annular shape in a circumferential direction along the sliding surface, and the slit being formed so as to allow communication from a side surface of the sealing member to the groove, and
the sealing member includes a contamination sealing portion which functions as a contamination seal and a hydraulic sealing portion which functions as a hydraulic seal, the contamination sealing portion being formed of a portion of the sliding surface disposed at a position outward from the groove, and the hydraulic sealing portion being formed of a portion of the sliding surface disposed at a position inward from the groove.

2. The sealing device according to claim 1, wherein surface roughness of the portion of the sliding surface forming the contamination sealing portion is greater than surface roughness of the portion of the sliding surface forming the hydraulic sealing portion.

3. The sealing device according to claim 1, wherein a depth of the slit is set equal to a depth of the groove.

4. The sealing device according to claim 1, wherein the slit increases in dimension from the groove to the side surface of the sealing member.
